(19) United States
(12) Patent Application Publication
(10) Pub. No.: US 2025/0054674 A1
(43) Pub. Date: Feb. 13, 2025

(54) INDUCTOR

(71) Applicant: Panasonic Intellectual Property Management Co., Ltd., Osaka (JP)

(72) Inventors: YOICHI NISHIJIMA, Osaka (JP); KENJI UENO, Fukui (JP); HIDENORI UEMATSU, Tokyo (JP); ATSUSHI TAKARADA, Osaka (JP); SHOTARO SUDO, Hyogo (JP)

(21) Appl. No.: 18/721,911

(22) PCT Filed: Nov. 18, 2022
(86) PCT No.: PCT/JP2022/042787

§ 371 Date: Jun. 20, 2024

(30) Foreign Application Priority Data
Feb. 16, 2022 (JP) 2022-021736

(51) Int. Cl. H01F 17/04; H01F 3/08; H01F 27/28

(52) U.S. Cl. CPC H01F 17/04; H01F 3/08; H01F 27/2823; H01F 2017/048

(57) ABSTRACT

An inductor includes a magnetic core made of powdery magnetic material and a binder which are mixed and pressure-molded, and a coil element embedded in the magnetic core. the coil element is wound to have a toroidal coil shape.

### TECHNICAL FIELD

The present disclosure relates to an inductor for use in various electronic devices.

### BACKGROUND ART

In recent years, with increasing performance of electronic devices, demands on inductors have become more diverse, aiming at achieving higher inductance, larger current, better superposition characteristics, etc. To this end, a toroidal coil has been proposed in which a conductive wire is wound about a toroidal core made of ferrite (for example, PTL 1). In addition, an inductor of pressure-molded powder type has been proposed in which a magnetic core is formed by embedding a coil element in a mixture powder of powdery metal magnetic and a binder composed of a thermosetting resin, followed by pressure-molding (for example, PTL 2).

### CITATION LIST

### Patent Literature

PTL 1: Japanese Patent Laid-Open Publication No. 2012-124396
PTL 2: Japanese Patent Laid-Open Publication No. 2010-87240

### SUMMARY OF INVENTION

An inductor includes a magnetic core made of powdery magnetic material and a binder which are mixed and pressure-molded, and a coil element embedded in the magnetic core. the coil element is wound to have a toroidal coil shape.

The inductor has a large increased initial inductance and reduces a decrease in the inductance even upon having a high current flow therein.

### BRIEF DESCRIPTION OF DRAWINGS

FIG. 1 is a perspective view of an inductor according to an exemplary embodiment of the present disclosure.

FIG. 2 is a cross-sectional view of the inductor along the line II-II shown in FIG. 1.

FIG. 3A is illustrates a method of manufacturing the inductor according to the embodiment.

FIG. 3B illustrates the method of manufacturing the inductor according to the embodiment.

FIG. 3C illustrates the method of manufacturing the inductor according to the embodiment.

FIG. 3D illustrates the method of manufacturing the inductor according to the embodiment.

### DESCRIPTION OF EMBODIMENT

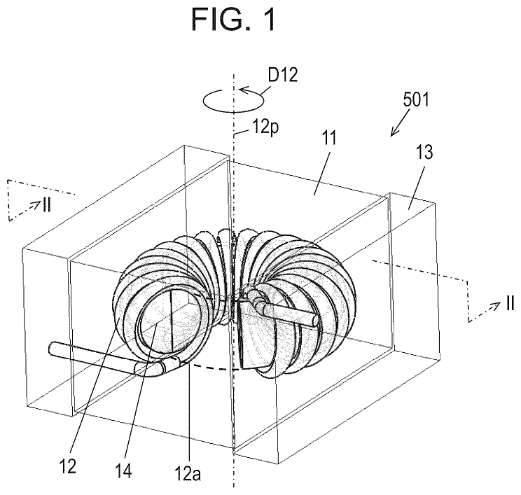

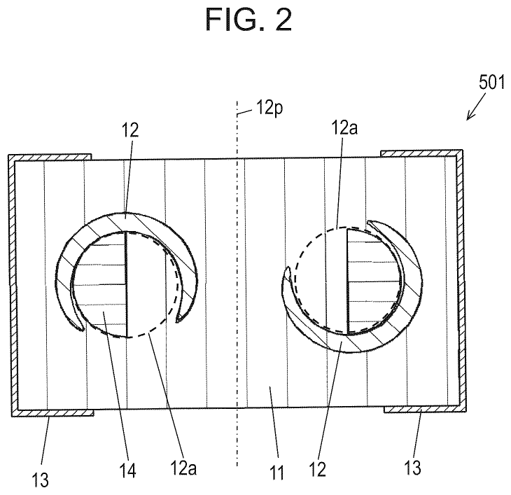

FIG. 1 is a perspective view of inductor 501 according to an exemplary embodiment of the present disclosure. FIG. 2 is a cross-sectional view of inductor 501 along line II-II shown in FIG. 1.

Inductor 501 includes magnetic core 11 and coil element 12 embedded in magnetic core 11.

Magnetic core 11 is formed by pressure-molding a composite magnetic material that has been prepared by mixing a binder and powdery metal magnetic material made of an Fe—Si—Cr alloy. Coil element 12 is embedded in magnetic core 11. End portions of coil element 12 protrude and are exposed from end surfaces of magnetic core 11, and connected electrically and mechanically to external electrodes 13 disposed on the end surfaces of magnetic core 11, respectively. An outer shape of magnetic core 11 is a rectangular parallelepiped shape having a size of approximately 7 mm square and a height of approximately 4 mm.

Coil element 12 is embedded in magnetic core 11. Coil element 12 is made of a conductive wire made of a copper wire with a diameter of about 0.3 mm, The copper wire is covered with an insulating coating and wound. The conductive wire of coil element 12 is helically wound along and about winding-core portion 12a, thus allowing coil element 12 to have a toroidal coil shape. Winding-core portion 12a is a virtual region having a toroidal shape and extending in circumferential direction D12 surrounding center axis 12p. The inner diameter of winding-core portion 12a of coil element 12 is about 2 mm. Ferrite material 14 is disposed in winding-core portion 12a of coil element 12 that has been wound in the toroidal coil shape. Ferrite material 14 is formed by sintering a ferrite powder into a C-shape, i.e., a doughnut shape having a part thereof cut.

The shape pf ferrite material 14 preferably has a C-shape or U-shape when viewed in a direction in which center axis 12p extends. A conductive wire is hardly wound helically about a ferrite material having a ring shape automatically. Ferrite material 14 with a C-shape or U-shape may be inserted into a coil composed of a conductive wire previously wound, resulting in ease of their assembling.

As described above, coil element 12 wound in such a toroidal coil shape enhances magnetic efficiency. Ferrite material 14 exhibiting a high initial magnetic permeability is increases the initial inductance at a low current. The metal magnetic material hardly undergoing magnetic saturation at a high current is used in magnetic core 11 to reduce the decrease in the inductance. In the toroidal coil including ferrite material 14 having a C-shape, a magnetic gap is formed at a portion of ferrite material 14 not continuously extending, leading to a decrease in the inductance. However, according to the embodiment of the present disclosure, the portion of ferrite material 14 not continuously extending is filled with the metal magnetic substance, i.e., the material of magnetic core 11, thus reducing the decrease in the inductance.

A toroidal coil has advantages of less leakage of magnetic flux and ease of achieving a high inductance, but has a problem of superposition characteristics in which, when passing a high current, its ferrite toroidal core undergoes magnetic saturation, resulting in a decrease in the inductance value. In addition, a conductive wire is hardly wound to provide a toroidal coil automatically, leading to high costs. On the other hand, although an inductor of pressure-molded powder type has preferable superposition characteristics relative to the toroidal coil, its superposition characteristics is still insufficient and its inductance is hardly increased.

Inductor 501 according to the embodiment reduces the decrease in the inductance, as described above.

The volume of ferrite material 14 is preferably equal to or less than 90% of the volume of winding-core portion 12a of coil element 12 wound in a toroidal coil shape. In the case where the volume of ferrite material 14 is more than 90% of the volume of winding-core portion 12a, the proportion of the metal magnetic material is small, resulting in the tendency for the inductance to decrease upon having a high current flow.

Ferrite material 14 is preferably disposed on the outer part of the toroidal shape as shown in FIG. 2. Since spaces between the conductive wires in coil element 12 are narrower on the inner side of the toroidal shape than on the outer side, the magnetic saturation is more likely to occur on the inner side of the toroidal shape of winding-core portion 12a than on the outer side. For this reason, the metal magnetic substance is disposed in a larger proportion on the inner side of the toroidal shape than on the outer side so as to cause the magnetic saturation to be hardly occur, and ferrite material 14 is disposed in a large proportion on the outer side of the toroidal shape so as to provide a high inductance.

In general, when a coil element wound in a toroidal coil shape is compression-molded while being loaded in a mold, the coil element often deforms due to pressure. Such deformation of the coil element results in variations in their inductance. On the other hand, according to the embodiment, the compression molding is performed while ferrite material 14 is placed in winding-core portion 12a of coil element 12 having been toroidally wound. This configuration allows ferrite material 14 to support coil element 12, and prevents coil element 12 from deforming, accordingly providing inductor 501 with a stable inductance.

In accordance with the embodiment described above, ferrite material 14 employs the sintered body of ferrite powder, it may employ another body that is made by mixing a resin to a ferrite powder, followed by hardening the resin. Even with a resin-hardened material, the same effect as described above can be achieved as long as it withstands the pressures of the compression molding.

Instead of the ferrite material, a metal magnetic powder may be used that is mixed with a resin and compressed and hardened into a C-shape or U-shape. This configuration also provides inductor 501 with preferable superposition characteristics.

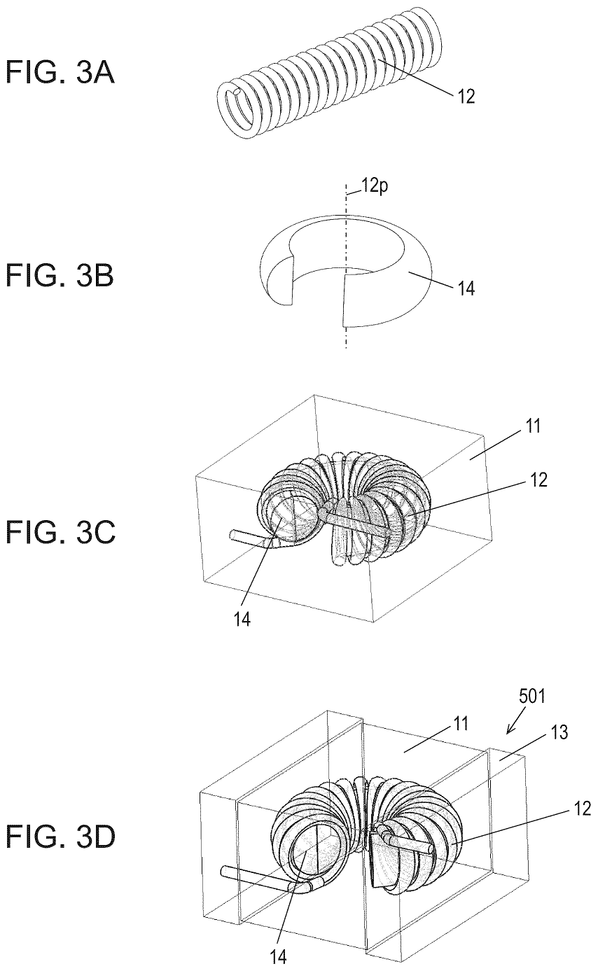

A method of manufacturing the inductor according to the embodiment of the present invention will be described below. FIGS. 3A-3D illustrate the method of manufacturing inductor 501.

First, a copper wire covered with an insulating coating is wound about a winding core and then removed from the winding core, thereby forming coil element 12, as shown in FIG. 3A. A ferrite powder is mixed with a binder, and then molded and sintered to produce ferrite material 14 with a C-shape, as shown in FIG. 3B. Ferrite material 14 may be produced by mixing a resin to a ferrite powder, followed by hardening the resin. Even the resin-hardened ferrite material provides the same effect as described above as long as it withstands the pressures of the compression molding.

Next, ferrite material 14 is inserted into winding-core portion 12a of coil element 12. Since ferrite material 14 has the C-shape, ferrite material 14 may be inserted through an open section of the C-shape being part of a ring into winding-core portion 12a of coil element 12. The insertion of ferrite material 14 having the C-shape into winding-core portion 12a of coil element 12 causes coil element 12 to have a structure of being wound in the toroidal coil shape. Use of such a manufacturing method results in ease of automation of the processes of winding for coil element 12, allowing a simplification of the assembling process.

Next, coil element 12 into which ferrite material 14 having been inserted is placed in a mold together with a composite magnetic material having prepared by mixing a binder and a powdery metal magnetic material composed of an Fe—Si—Cr alloy and subjected to pressure-molding to form magnetic core 11, thereby producing a molded body as shown in FIG. 3C. In this process, magnetic core 11 is formed such that both end portions of coil element 12 are exposed from end surfaces of magnetic core 11. After magnetic core 11 has been heat-cured, external electrodes 13 are formed on the end surfaces of magnetic core 11 from which both end portions of coil element 12 are exposed, thereby completing inductor 501 as shown in FIG. 3D.

### INDUSTRIAL APPLICABILITY

An inductor according to the present disclosure has excellent superposition characteristics and a high inductance. The inductor is usable in industrial applications.

### REFERENCE MARKS IN THE DRAWINGS

11 magnetic core
12 coil element
12a winding-core portion
13 external electrode
14 ferrite material

1. An inductor comprising:
a magnetic core made of powdery magnetic material and a binder which are mixed and pressure-molded;
a coil element embedded in the magnetic core, the coil element having an end portion exposed from an end surface of the magnetic core; and
an external electrode connected electrically and mechanically to the end portion of the coil element,
wherein the coil element is wound to have a toroidal coil shape.

2. The inductor according to claim 1,
wherein the coil element is helically wound about a winding core portion having a toroidal shape extending in a circumferential direction surrounding a center axis of the toroidal shape, and
wherein the inductor further includes a ferrite material disposed in the winding core portion of the magnetic core.

3. The inductor according to claim 2, wherein the ferrite material has either a C-shape or a U-shape when viewed in a direction in which the center axis extends.

4. The inductor according to claim 2, wherein a volume of the ferrite material is equal to or less than 90% of a volume of the winding core portion.
